(19) United States
(12) Patent Application Publication
(10) Pub. No.: US 2019/0374313 A1
(43) Pub. Date: Dec. 12, 2019

(54) IMPLANT ATTACHMENT SYSTEM

(71) Applicant: APOLLONIAN HOLDINGS LLC, Simi Valley, CA (US)

(72) Inventor: Sargon Lazarof, Encino, CA (US)

(21) Appl. No.: 16/435,135

(22) Filed: Jun. 7, 2019

Related U.S. Application Data
(60) Provisional application No. 62/682,149, filed on Jun. 7, 2018.
(60) Provisional application No. 62/700,803, filed on Jul. 19, 2018.

(51) Int. Cl. A61C 8/00

(52) U.S. Cl. CPC A61C 8/0062; A61C 8/0057; A61C 8/0095; A61C 8/0071; A61C 8/0051

(57) ABSTRACT

Mechanisms for securing an abutment, removable prosthesis, and/or a fixed prosthesis to an implant without screws or cement are provided. At least a portion of an abutment and/or a fixed prosthesis may be formed from a resilient material to enable the abutment and/or the fixed prosthesis to be secured to secured to the implant without screws or cement. Alternatively, a removable prosthesis may include a spring-loaded snap fastener for securing the removable prosthesis to an implant without screws or cement. The spring-loaded snap fastener may include a metal coil having at least three turns disposed in a same plane. The spring-loaded snap fastener may secure the removable prosthesis to the implant by at least gripping a groove disposed at least a partially around an interface between the removable prosthesis and the implant.

### CROSS-REFERENCE TO RELATED APPLICATIONS

This application claims priority to U.S. Provisional Application No. 62/682,149, filed Jun. 7, 2018, and U.S. Provisional Application No. 62/700,803, filed Jul. 19, 2018, which are hereby incorporated by reference in their entirety and for all purposes.

### TECHNICAL FIELD

The subject matter disclosed herein relates to generally to medical devices and more specifically to an implant attachment system.

### SUMMARY

Methods and articles of manufacture for securing an apparatus to an implant are provided. In one aspect, there is provided an apparatus. The apparatus may be configured to couple with an implant as an abutment and/or a fixed prosthesis, with at least a portion of the apparatus being formed from a flexible material that enables the apparatus to be secured to the implant without screws or cement.

In some variations, one or more features disclosed herein including the following features may optionally be included in any feasible combination. The apparatus may be secured to the implant by at least coupling with an interface included with the implant.

In some variations, the size of the interface may be determined based at least on a size of the implant and/or a size of the apparatus.

In some variations, the interface and the implant may form a single continuous piece.

In some variations, the interface may be attached to the implant by screwing and/or welding.

In some variations, a lateral surface of the interface may be tapered to form a Morse taper.

In some variations, the portion of the apparatus formed from the flexible material may be configured to respond to pressure applied to the apparatus by at least flexing to accommodate the interface, and the flexible material may be further configured to contract in order to grip the interface and secure the apparatus to the implant. The portion of the apparatus may include a flange disposed along a perimeter of the apparatus.

In some variations, the fixed prosthesis includes a crown or a bridge.

In another aspect, there is provided a method, including removing the apparatus by at least inserting a moveable element between the apparatus the interface.

In another aspect, there is provided an apparatus configured to couple with an implant as a removable prosthesis. The apparatus may include a spring-loaded snap fastener disposed in a socket in the apparatus. The spring-loaded snap fastener may be configured to secure the apparatus to the implant without screws or cement.

In some variations, one or more features disclosed herein including the following features may optionally be included in any feasible combination. In some variations, the spring-loaded snap fastener includes a metal coil.

In some variations, the metal coil is configured to expand in response to pressure applied to the apparatus. The metal coil may expand in order to accommodate an interface between the implant and the apparatus, when the apparatus is slid over the interface between the implant and the apparatus. The metal coil may rest inside a groove disposed along the interface between the implant and the apparatus, when the apparatus is positioned on the implant.

In some variations, the metal coil is further configured to contract and grip the interface when the metal coil is resting inside the groove. The metal coil may include a flat spring having a plurality of turns disposed in a same plane. The flat spring may enable the apparatus to swivel and/or rotate when the apparatus is secured to the implant. The spring may include at least three turns. The spring may include five turns.

In some variations, the removable prosthesis includes dentures.

In another aspect, there is provided a method including securing to an implant to the apparatus described herein. The method may include applying pressure to the apparatus.

In another aspect, there is provided a metal coil. In some variations, one or more features disclosed herein including the following features may optionally be included in any feasible combination. The coil may form a flat coil wire form spring having at least three turns disposed in a same plane. The metal coil may be configured to be disposed in an apparatus including a removable prosthesis. The metal coil may be further configured to secure the apparatus to an implant, including by gripping a groove disposed at least partially around an interface between the implant and the apparatus.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a dental implant or other types of implants, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of an attachment mechanism for securing an apparatus to an implant consistent with implementations of the current subject matter;

FIG. 2 depicts an example of a technique for removing an apparatus from an implant consistent with implementations of the current subject matter;

FIG. 3 depicts another example of a technique for removing an apparatus from an implant consistent with implementations of the current subject matter;

FIG. 4 depicts a cross sectional view of another example of an attachment mechanism for securing an apparatus to an implant consistent with implementations of the current subject matter;

FIG. 5 depicts another cross sectional view of the example of the attachment mechanism for securing an apparatus to an implant consistent with implementations of the current subject matter;

FIG. 6 depicts an exterior view of the example of the attachment mechanism for securing an apparatus to an implant consistent with implementations of the current subject matter;

FIG. 7 depicts an example of a metal coil forming a spring-loaded snap fastener consistent with implementations of the current subject matter;

FIG. 8 depicts another cross sectional view of the example of the attachment mechanism for securing an apparatus to an implant consistent with implementations of the current subject matter; and

FIG. 9 depicts another cross sectional view of the example of the attachment mechanism for securing an apparatus to an implant consistent with implementations of the current subject matter.

When practical, similar reference numbers denote similar structures, features, or elements.

### DETAILED DESCRIPTION

Screws are a common mechanism for securing an abutment and/or a fixed prosthesis to an implant such as, for example, a dental implant and/or the like. But screws may leave unsightly access holes in the abutment and/or the fixed prosthesis that must be filled with dental filings. Furthermore, screws can also loosen and/or fracture over time. Alternatively and/or additionally, cement can also be used for securing an abutment and/or a fixed prosthesis to an implant. However, an abutment and/or a fixed prosthesis that is secured using cement cannot be removed without destroying the abutment and/or the fixed prosthesis. Excess cement left in the gum and/or jawbone of a patient can further cause damage to the implant itself. As such, in some implementations of the current subject matter, an abutment and/or a fixed prosthesis can be secured to an implant by a snap fit and/or a friction fit mechanism. Securing an abutment and/or a fixed prosthesis to an implant by a snap fit and/or a friction fit mechanism obviates the need for dental fillings, or the use of cement prone to causing damage to the implant. Securing an abutment and/or a fixed prosthesis to an implant by a snap fit and/or a friction fit mechanism also ensures that the abutment and/or fixed prosthesis can be removed without being destroyed.

In some implementations of the current subject matter, at least a portion of an abutment and/or a fixed prosthesis can be formed from a resilient material. For example, at least a portion of the abutment and/or the fixed prosthesis can be formed from a thermal plastic such as, for example, polyoxymethylene and/or the like. At least a portion of the resulting abutment and/or fixed prosthesis may exhibit flexibility. As such, forming at least a portion of the abutment and/or the fixed prosthesis from the resilient material can enable the abutment and/or the fixed prosthesis to be fastened to an implant by being snapped and/or pushed onto the implant. For instance, applying pressure to the abutment and/or the fixed prosthesis may cause the portion of the abutment and/or the fixed prosthesis formed from the resilient material to flex, thereby enabling the abutment and/or the fixed prosthesis to couple with an interface between the implant and the abutment and/or fixed prosthesis.

In some implementations of the current subject matter, at least the portion of the abutment and/or fixed prosthesis formed from a flexible material may flex to accommodate attachment to an implant by being snapped and/or pushed onto the implant. Furthermore, the abutment and/or the fixed prosthesis can remain secured to the implant by snap fit and/or friction fit. To receive the abutment and/or the fixed prosthesis, the implant may include an interface configured to couple with the abutment and/or fixed prosthesis. The lateral surface of the interface may be tapered such that a diameter of the interface gradually increases from a proximate end of the interface towards a distal end of the interface. For example, the lateral surface of the interface may exhibit a Morse taper.

As used herein, an abutment refers to an apparatus configured to form a coupling between an implant and a fixed prosthesis such as, for example, a crown, a bridge, and/or the like. However, as noted, an abutment and/or a fixed prosthesis that is secured to an implant using conventional mechanisms (e.g., screws, cement, and/or the like) cannot be removed without destroying the abutment and/or the fixed prosthesis. As such, in some implementations of the current subject matter, an abutment can include a secondary instrument and/or a moveable element to enable removal of the fixed prosthesis without causing any damage and/or destruction to the fixed prosthesis.

In some implementations of the current subject matter, a biocompatible and/or bio-absorbable cement can be used to further secure an abutment and/or a fixed prosthesis to an implant. As noted, conventional cement can cause damage to the implant, for example, when an excess of the cement is left in the gum and/or jawbone of a patient. By contrast, a biocompatible and/or bio-absorbable cement can be absorbed by the body. As such, a biocompatible and/or bio-absorbable cement can be left in the gum and/or jawbone of a patient without causing any damage to the implant.

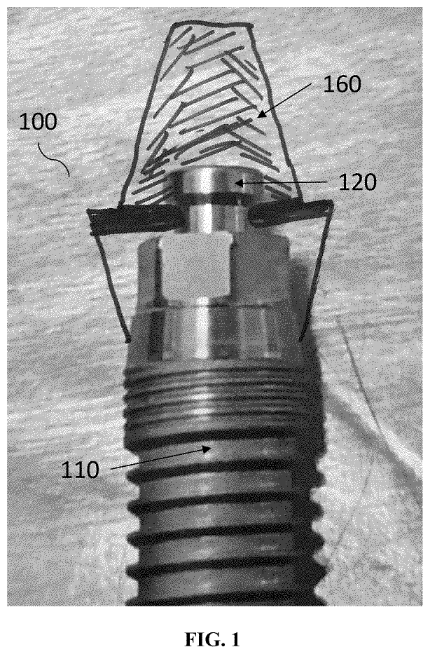

To further illustrate, FIGS. 1-3 depict an example of an attachment mechanism for securing, via friction fit, an abutment and/or a fixed prosthesis to an implant. As used herein, a “fixed prosthetic” refers to a prosthesis (e.g., a crown, a bridge, and/or the like) that is typically secured to an implant by screw or by cement. Likewise, an abutment is also typically secured to an implant by screw or by cement. As shown in FIG. 1, various implementations of the current subject matter enables the abutment and/or the fixed prosthetic to be secured to an implant without screws or cement. Instead, in the example shown in FIG. 1, the abutment or the fixed prosthetic may be secured to the implant by friction fit and/or snap fit as provided a flexible material forming at least a portion of the abutment and/or the fixed prosthesis.

Referring to FIG. 1, an implant 100 may include an implant body 110. Moreover, the implant 100 may include an interface 120. As shown in FIG. 1, an apparatus 160 may be attached to the implant by at least coupling with the interface 120. In some implementations of the current subject matter, the interface 120 and the implant 100 may form a single continuous piece. Alternatively the interface 120 may be separate from the implant 100 and attached to the implant 100 by any mechanism including, for example, screwing, welding, and/or the like.

In some implementations of the current subject matter, the apparatus 160 may be an abutment. Alternatively and/or additionally, the apparatus 160 may be a fixed prosthesis such as, for example, a crown, a bridge, and/or the like. As such, the size of the apparatus 160 may vary. The size of the interface 120 may therefore vary in order to accommodate the variations in the size of the apparatus 160. Moreover, the implant 100 may be any type of implant including, for example, an expandable implant having a hollow body that includes a plurality of skirts, which are expandable upon insertion of an expansion screw. Expandable implants are described in more detail in U.S. Pat. Nos. 8,828,066 and 8,696,720, the disclosures of which are incorporated herein by reference in their entirety. It should be appreciated that the expansion and contraction of the apparatus 160 may enable the apparatus 160 to accommodate for variations in the size of the implant 100 and/or the interface 120.

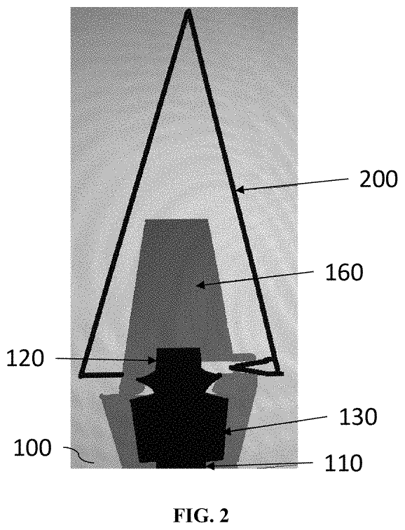

In some implementations of the current subject matter, the lateral surface of the interface 120 between the implant 100 and the apparatus 160 may be tapered such that a diameter of the interface 120 between the implant 100 and the apparatus 160 may exhibit a gradual increase from a proximate end of the interface 120 towards a distal end of the interface 120. For example, as shown in FIG. 2, the lateral surface of the interface 120 may exhibit a Morse taper 130. The interface 120 between the implant 100 and the apparatus 160 may be tapered to at least facilitate the coupling of the apparatus 160 and the interface 120.

In the example shown in FIGS. 1-3, at least a portion of the apparatus 160 may be formed from a resilient material such as, for example, a thermal plastic (e.g., polyoxymethylene and/or the like). At least a portion of the apparatus 160 may therefore be flexible, which may enable the apparatus 160 to be secured over the interface 120 between the implant 100 and the apparatus 160. Applying pressure to the apparatus 160 may cause at least a portion of the apparatus 160 to flex, which enables the apparatus 160 to slide over the interface 120 between the implant 100 and the apparatus 160.

For example, the perimeter (e.g., the lower perimeter) of the apparatus 160 may include a flange 170 that is formed from a resilient material (e.g., a thermal plastic and/or the like). The flange 170 may therefore be flexible and able to flex to accommodate the interface 120 between the implant 100 and the apparatus 160 as the apparatus 160 is slid over the interface 120. As shown in FIGS. 1-3, the flange 170 may form a recess and/or a cavity in the apparatus 160 configured to receive the interface 120. Moreover, when the apparatus 160 is in position over the interface 120, the flange 170 may contract to grip the interface 120. For instance, as shown in FIGS. 1-3, upon contracting, the flange 170 may grip the interface 120, thereby securing the apparatus 160 to the interface 120.

In some implementations of the current subject matter, the apparatus 160 may be secured to the interface 120 without screws or dental cement. Instead, as noted, the apparatus 160 may be secured to the interface 120 by the flange 170 gripping the interface 120 when the apparatus 160 is coupled with the interface 120.

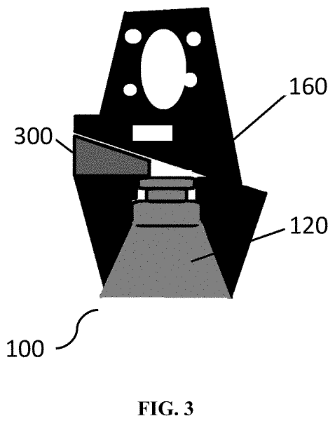

In some implementations of the current subject matter, a variety of techniques may be used to remove the apparatus 160 from the implant 100. For example, FIG. 2 shows a removal tool 200 being positioned to remove the apparatus 160 from the interface 120 between the implant 100 and the apparatus 160. Alternatively and/or additionally, FIG. 3 shows an element 300 being inserted through at least a portion of the apparatus 160 to dislodge the apparatus 160 from the interface 120 between the implant 100 and the apparatus 160. It should be appreciated that the snap fit or friction fit securing the apparatus 160 to the implant 100 may facilitate the removal of the apparatus from the implant 100, especially when compared to a conventional securing mechanism that requires either screws or cement.

Alternatively, an abutment, a removable prosthesis, and/or a fixed prosthesis may include a spring-loaded snap fastener for securing the abutment, the removable prosthesis, and/or the fixed prosthesis to an implant. The spring-loaded snap fastener may include a spring that is disposed at least partially around a socket within the abutment and/or the fixed prosthesis. The socket within the abutment, the removable prosthesis, and/or the fixed prosthesis may be a recess or a cavity configured to at least partially receive a protrusion. The implant may be configured to include a protrusion, and the socket within the abutment, the removable prosthesis, and/or the fixed prosthesis may at least partially receive at least a portion of the protrusion of the implant. As used herein, a “removable prosthesis” refers to a prosthesis (e.g., dentures and/or the like) that is not permanently or semi-permanently secured to an implant, for example, by screws and/or by cement. By contrast, as noted, a “fixed prosthetic” refers to a prosthesis (e.g., a crown, a bridge, and/or the like) that is typically secured to an implant by screw or by cement.

Applying pressure to the abutment, the removable prosthesis, and/or the fixed prosthesis may secure the abutment, the removable prosthesis, and/or the fixed prosthesis to the implant including by coupling the abutment, the removable prosthesis, and/or the fixed prosthesis to an interface included with the implant. For example, the application of pressure may insert the interface and/or at least a portion of a body of the implant into the socket within the abutment, the removable prosthesis, and/or the fixed prosthesis. Furthermore, once the abutment, the removable prosthesis, and/or the fixed prosthesis is positioned over the implant, the spring may secure the abutment, the removable prosthesis, and/or the fixed prosthesis to the implant by at least gripping the implant, for example, around a groove disposed at least partially around a lateral surface of the interface. It should be appreciated that the spring-loaded snap fastener may enable the abutment, the removable prosthesis, and/or the fixed prosthesis to be secured to the implant without requiring screws and/or cement.

In some implementations of the current subject matter, the spring-loaded snap fastener may include a metal coil disposed at least partially around the socket within the abutment, the removable prosthesis, and/or the fixed prosthesis. Furthermore, the metal coil may be shaped to form a flat coil wire form spring. As such, the implant may be inserted into the socket by applying, to the abutment, the removable prosthesis, and/or the fixed prosthesis, sufficient pressure to push apart the flat coil wire form spring. Once the abutment, the removable prosthesis, and/or the fixed prosthesis is inserted into the socket, the abutment, the removable prosthesis, and/or the fixed prosthesis may be further secured to the implant by the flat coil wire form spring gripping the interface, for example, around the groove in the interface.

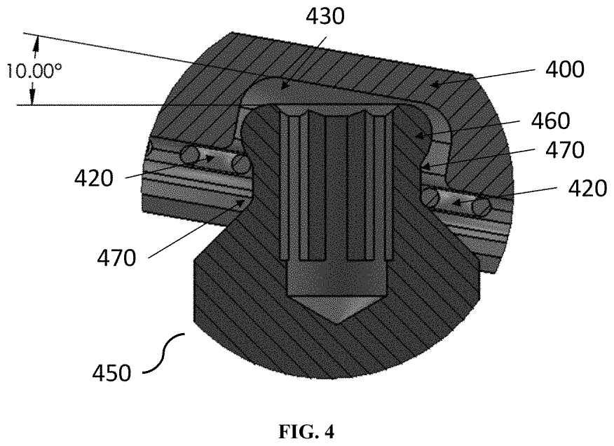

To further illustrate, FIGS. 4-7 depict an example of an apparatus 400 that include a spring-loaded snap fastener 410. The apparatus 400 may be a removable prosthesis including, for example, dentures and/or the like. Alternatively and/or additionally, the apparatus 400 may be an abutment or a fixed prosthesis such as, for example, a crown, a bridge, and/or the like.

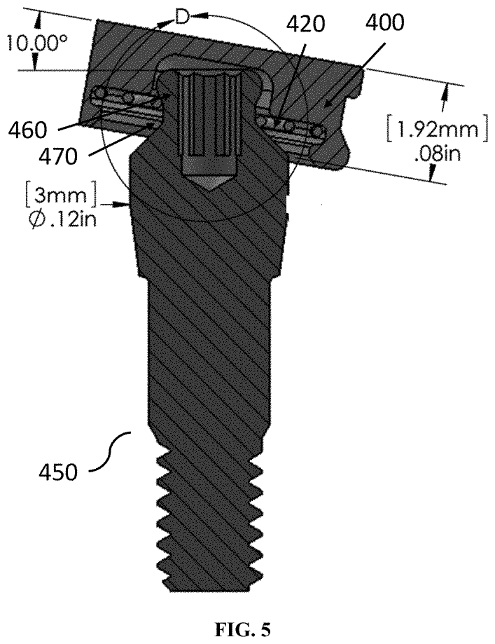

In the example shown in FIGS. 4-7, the spring-loaded snap fastener 410 may include a metal coil 420 which, as shown in FIGS. 4-5, may be disposed at least partially around a socket 430 within the apparatus 400. The apparatus 400 may be secured to an implant 450 by at least applying, to the apparatus 400, pressure to at least insert an interface 460 between the implant 450 and the apparatus 400 into the socket 430 within the apparatus 400. For example, the pressure may expand at least a portion of the metal coil 420 to slide the apparatus 400 over the interface 460 between the implant 450 and the apparatus 400. Once the apparatus 400 is positioned over the implant 450, the metal coil 420 may secure the apparatus 400 to the implant 450 by at least gripping the implant 450, for example, around a groove 470 disposed along the interface 460 between the implant 450 and the apparatus 400.

It should be appreciated that the size of the interface 460 may vary in order to accommodate variations in the size of the apparatus 400. The size of the implant 450 may also vary because the apparatus 400 may be configured to accommodate different sized implants. Moreover, the implant 450 may be any type of implant including, for example, an expandable implant having a hollow body that includes a plurality of skirts, which are expandable upon insertion of an expansion screw. As noted, expandable implants are described in more detail in U.S. Pat. Nos. 8,828,066 and 8,696,720, the disclosures of which are incorporated herein by reference in their entirety.

FIGS. 4-5 depict cross sectional views of the apparatus 400 being positioned on the interface 460 between the implant 450 and the apparatus 400. As shown in FIGS. 4-5, the apparatus 400 may have a diameter of approximately 5.59 millimeters and a thickness of approximately 1.92 millimeters, although the apparatus 400 may have one or more different dimensions than shown. Furthermore, as shown in FIGS. 4-5, the apparatus 400 may be slid over the interface 460 between the implant 450 and the apparatus 400 at an angle.

For example, FIGS. 4-5 show the apparatus 400 being disposed at an angle of approximately 10.00 degrees relative to the interface 460 between the implant 450 and the apparatus 400 in order for one side of the metal coil 420 to rest against the groove 470 in the interface 460 between the implant 450 and the apparatus 400. Pressure may be applied to the apparatus 400 to bring the opposite side of the metal coil 420 to rest inside groove 470 in the interface 460 between the implant 450 and the apparatus 400. The pressure may expand at least a portion of the metal coil 420 to accommodate the interface 460 between the implant 450 and the apparatus 400 and allow the interface 460 between the implant 450 and the apparatus 400 to enter the socket 430 of the apparatus 400 as the apparatus 400 is slid over the interface 460 between the implant 450 and the apparatus 400.

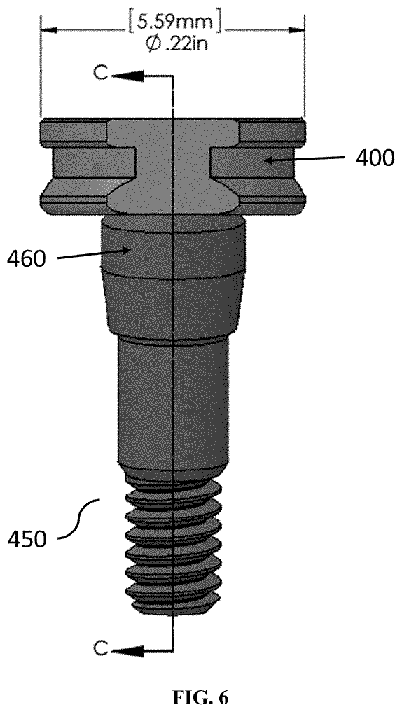

FIG. 6 depicts an exterior view of the apparatus 400 after the apparatus 400 has been secured to the interface 460 between the implant 450 and the apparatus 400. As noted, the apparatus 400 may be secured to the interface 460 between the implant 450 and the apparatus 400 when the metal coil 420 inside the socket 430 of the apparatus 400 is resting inside the groove 470 along the interface 460 between the implant 450 and the apparatus 400 such that the metal coil 420 is gripping the implant 450 around the groove 470. Moreover, in some implementations of the current subject matter, a biocompatible and/or bio-absorbable cement can be used to further secure the apparatus 400 to the interface 460 between the implant 450 and the apparatus 400. Unlike conventional cement that can damage the implant 450, a biocompatible and/or bio-absorbable cement can be absorbed by the body and is therefore harmless to the implant 450, even when an excess quantity of the biocompatible and/or bio-absorbable cement is left in the gum and/or jawbone of a patient.

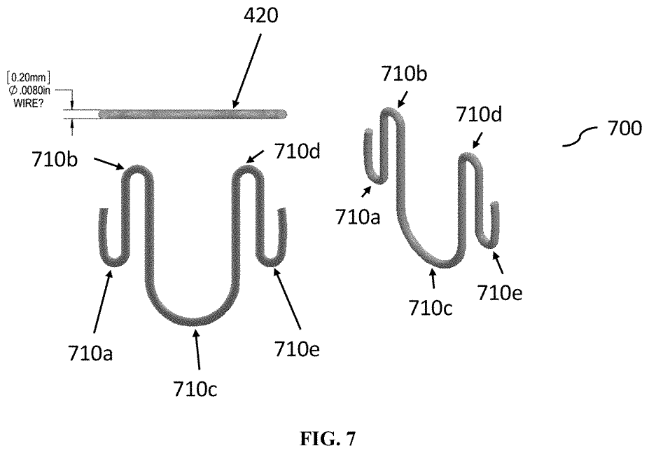

FIG. 7 depicts an example of the metal coil 420 consistent with some implementations of the current subject matter. In the example shown in FIG. 7, the metal coil 420 may be shaped to form a flat coil wire form spring 700. The flat coil wire form spring 700 may be planar, having each turn of the wire in the same plane. In some implementations of the current subject matter, the flat coil wire form spring 700 may be configured to have at least three turns. The flat coil wire form spring 700 may be configured to provide the apparatus 400 with freedom of movement (e.g., to swivel, rotate, and/or the like), thereby preventing the apparatus 400 from overloading the implant 450. This freedom of movement may be desirable when the apparatus 400 is a removable prosthesis such as, for example, dentures and/or the like. By contrast, when the apparatus 400 is an abutment and/or a fixed prosthesis, the apparatus 400 (e.g., the metal coil 420, the socket 430, and/or the like), the interface 460, and/or the placement of the apparatus 400 may be configured to minimize and/or eliminate freedom of movement, thereby preventing the apparatus from swiveling, rotating, and/or the like.

In the example shown in FIG. 7, the flat coil wire form spring 700 may include five turns including a central turn 710c interposed between two turns 710b and 710d and two additional turns 710a and 710e flanking turns 710b and 710d. The turns may be equal in diameter. Alternatively, at least some of the turns may have a different diameter. For instance, as shown in FIG. 7, the central turn 710c may have a larger diameter than the turns 710a, 710b, 710d, and 710e while the respective diameters of turns 710a, 710b, 710d, and 710e are substantially the same.

The implant 450 may be inserted into the socket 430 of the apparatus 420 by at least applying, to the apparatus 400, sufficient pressure to push apart at least a portion of the flat coil wire form spring 700. For example, the second and fourth turns 710b and 710d of the flat coil wire form spring 700 may be pushed apart to accommodate the interface 460 between the implant 450 and the apparatus 400, thereby enabling the interface 460 between the implant 450 and the apparatus 400 to enter the socket 430 of the apparatus and for the apparatus 400 to be slid over the interface 460 between the implant 450 and the apparatus 400. Once the flat coil wire form spring 700 are resting inside the groove 470 along the interface 460 between the implant 450 and the apparatus 400, the flat coil wire form spring 700 (e.g., the second and fourth turns 710b and 710d) may contract to grip the interface 460, for example, along the groove 470.

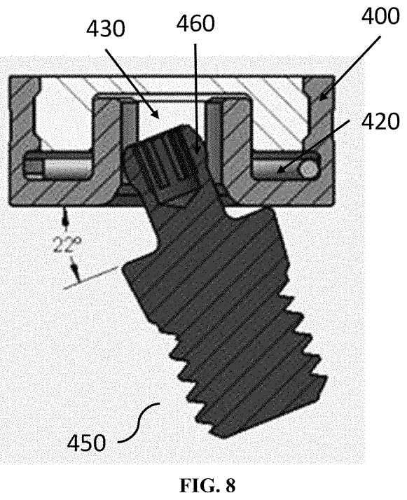

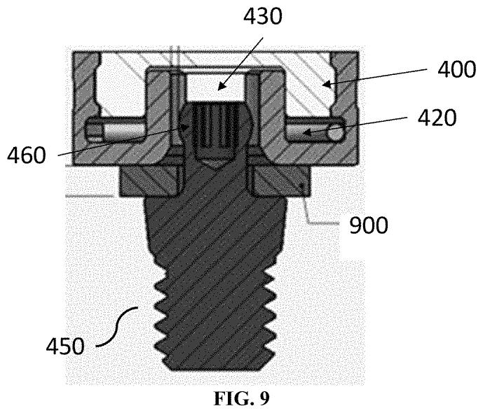

FIGS. 8-9 depict additional cross sectional views of the apparatus 400 being positioned on the interface 460 between the implant 450 and the apparatus 400. As shown in FIG. 8, the apparatus 400 may be slid over the interface 460 between the implant 450 and the apparatus 400 at an angle.

For example, FIG. 8 shows the apparatus 400 being disposed at an angle of approximately 22.00 degrees relative to the interface 460 between the implant 450 and the apparatus 400 in order for one side of the metal coil 420 to rest against the groove in the interface 460 between the implant 450 and the apparatus 400. Pressure may be applied to the apparatus 400 to bring the opposite side of the metal coil 420 to rest inside groove 470 in the interface 460 between the implant 450 and the apparatus 400. The pressure may expand at least a portion of the metal coil 420 to accommodate the interface 460 between the implant 450 and the apparatus 400 and allow the t interface 460 between the implant 450 and the apparatus 400 to enter the socket 430 of the apparatus 400 as the apparatus 400 is slid over the interface 460 between the implant 450 and the apparatus 400.

Referring now to FIG. 9, in some implementations of the current subject matter, a block out spacer 900 may be interposed between the apparatus 400 and the interface 460 between the implant 450 and the apparatus 400. For example, the block out spacer 900 may be disposed at least partially around a perimeter of the interface 460 between the implant 450 and the apparatus 400 to provide an additional interface between the apparatus 400 and the interface 460 between the implant 450 and the apparatus 400.

In some implementations of the current subject matter, at least a portion of the block out spacer 900 can be formed from an elastic material such as, for example, silicone and/or the like. Accordingly, at least a portion of the block out spacer 900 may be flexible, thereby enabling the block out spacer 900 to provide an additional interface between the apparatus 400 and the interface 460 between the implant 450 and the apparatus 400 to at least prevent dental materials from improperly contacting the implant 450 and potentially causing damage to the implant 450, the apparatus 400, the block out spacer 900, and/or to the patient. Furthermore, the block out spacer 900 may provide adequate spacing between the apparatus 400 and interface 460 between the implant 450 and the apparatus 400 to at least prevent the apparatus 400 from overloading the implant 450. For instance, the block out spacer 900 may provide the apparatus 400 with freedom of movement (e.g., to swivel, rotate, and/or the like), thereby preventing the apparatus 400 from overloading the implant 450.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An apparatus configured to couple with an implant as an abutment and/or a fixed prosthesis, at least a portion of the apparatus being formed from a flexible material that enables the apparatus to be secured to the implant without screws or cement.

2. The apparatus of claim 1, wherein the apparatus is secured to the implant by at least coupling with an interface included with the implant.

3. The apparatus of claim 2, wherein a size of the interface is determined based at least on a size of the implant and/or a size of the apparatus.

4. The apparatus of claim 2, wherein the interface and the implant forms a single continuous piece.

5. The apparatus of claim 2, wherein the interface is attached to the implant by screwing and/or welding.

6. The apparatus of claim 2, wherein a lateral surface of the interface is tapered to form a Morse taper.

7. The apparatus of claim 2, wherein the portion of the apparatus formed from the flexible material is configured to respond to pressure applied to the apparatus by at least flexing to accommodate the interface, and wherein the flexible material is further configured to contract in order to grip the interface and secure the apparatus to the implant.

8. The apparatus of claim 7, wherein the portion of the apparatus comprises a flange disposed along a perimeter of the apparatus.

9. The apparatus of claim 1, wherein the fixed prosthesis comprises a crown or a bridge.

10. A method, comprising:
removing the apparatus of claim 2 by at least inserting a moveable element between the apparatus the interface.

11. An apparatus configured to couple with an implant as a removable prosthesis, the apparatus including a spring-loaded snap fastener disposed in a socket in the apparatus, and the spring-loaded snap fastener configured to secure the apparatus to the implant without screws or cement.

12. The apparatus of claim 11, wherein the spring-loaded snap fastener includes a metal coil.

13. The apparatus of claim 12, wherein the metal coil is configured to expand in response to pressure applied to the apparatus, wherein the metal coil expands in order to accommodate an interface between the implant and the apparatus when the apparatus is slid over the interface between the implant and the apparatus, and wherein the metal coil rests inside a groove disposed along the interface between the implant and the apparatus when the apparatus is positioned on the implant.

14. The apparatus of claim 13, wherein the metal coil is further configured to contract and grip the interface when the metal coil is resting inside the groove.

15. The apparatus of claim 12, wherein the metal coil comprises a flat spring having a plurality of turns disposed in a same plane.

16. The apparatus of claim 15, wherein the flat spring enables the apparatus to swivel and/or rotate when the apparatus is secured to the implant.

17. The apparatus of claim 12, wherein the spring includes at least three turns.

18. The apparatus of claim 12, wherein the spring includes five turns.

19. The apparatus of claim 12, wherein the removable prosthesis comprises dentures.

20. A method, comprising:
securing, to an implant, the apparatus of claim 11 including by applying pressure to the apparatus.

21. A metal coil forming a flat coil wire form spring having at least three turns disposed in a same plane, the metal coil configured to be disposed in an apparatus comprising removable prosthesis, the metal coil further configured to secure the apparatus to an implant including by gripping a groove disposed at least partially around an interface between the implant and the apparatus.
